(19) United States
(12) Patent Application Publication
(10) Pub. No.: US 2017/0240184 A1
(43) Pub. Date: Aug. 24, 2017

(54) METHOD FOR OPERATING A DRIVER ASSISTANCE FUNCTION

(71) Applicant: Robert Bosch GmbH, Stuttgart (DE)

(72) Inventors: Stefan KLUEVER, Oeffingen (DE); Stefan GOTTLIEB, Hemmingen (DE)

(21) Appl. No.: 15/518,518

(22) PCT Filed: Sep. 1, 2015
(86) PCT No.: PCT/EP2015/069935

§ 371 Date: Apr. 12, 2017

(30) Foreign Application Priority Data
Oct. 29, 2014 (DE) 102014222058.0

(51) Int. Cl. B60W 50/10; B60W 30/12; B60W 30/095; B60W 50/14

(52) U.S. Cl. CPC B60W 50/10; B60W 50/14; B60W 30/12; B60W 30/0956; B60W 2420/52; B60W 2420/42; B60W 2550/10

(57) ABSTRACT

A method for operating a driver assistance function of a motor vehicle for maintaining a lane, including monitoring a lane on which the motor vehicle is moving, ascertaining a lane boundary of the lane, ascertaining a relative position of the motor vehicle with respect to the lane boundary, carrying out a control intervention in the motor vehicle as a function of a setpoint position of the motor vehicle relative to the lane boundary in order to keep the motor vehicle in the lane, ascertaining objects in the area of the lane, and adapting the control intervention as a function of the objects.

### FIELD

The present invention relates to a method for operating a driver assistance function of a motor vehicle for maintaining a lane. The present invention furthermore relates to a corresponding control and evaluation unit. Additionally, the present invention relates to a corresponding computer program product and to a storage medium including the computer program product.

### BACKGROUND INFORMATION

Conventional driver assistance functions in motor vehicles are available. Driver assistance functions for maintaining a lane, so-called lane keeping assistant systems, are also available in the market. Lane keeping assistant systems support the driver in keeping the motor vehicle in the present lane. This may take place, for example, by driving instructions, warning signals or control interventions. Moreover, conventionally, the lane keeping assistant system may be shut off when a turn signal is used, which indicates a lane change. In this way, it is achieved that a driver is not unnecessarily impaired by warning signals or automatic control interventions during a desired lane change. When no turn signal is activated, these systems attempt to prevent the vehicle from crossing a boundary line of a traffic lane by carrying out a corresponding steering or braking intervention. The steering or braking intervention takes place in such a way that the motor vehicle is kept in the lane.

However, there are situations in everyday traffic, in particular in the inner city, in which crossing the center line is intended, where frequently no turn signal is used. This is in particular the case when an obstacle is situated in, or in the vicinity of, the vehicle's own lane, such as a parking vehicle or a bicyclist. In such cases, a driver is only trying to avoid this obstacle or maintain a safe distance from the obstacle, it being necessary in some circumstances to cross a lane marking. In such cases, however, a triggering of the lane keeping assistant system is undesirable since this may result in confusion of the driver or, in the case of vehicle interventions, a hazard to the driver and other road users.

### SUMMARY

A method for operating a driver assistance function of a motor vehicle for maintaining a lane in accordance with the present invention includes the following steps:
monitoring a lane in which the motor vehicle is moving;
ascertaining a lane boundary of the lane;
identifying a relative position of the motor vehicle with respect to the lane boundary;
carrying out a control intervention in the motor vehicle as a function of a setpoint position of the motor vehicle relative to the lane boundary in order to keep the motor vehicle in the lane;
ascertaining objects in the area of the lane; and
adapting the control intervention as a function of the objects.

A control and evaluation unit in accordance with the present invention may be designed to provide a driver assistance function for a motor vehicle which maintains a lane, monitoring a lane in which the motor vehicle is moving, ascertaining a lane boundary of the lane, ascertaining a relative position of the motor vehicle with respect to the lane boundary, carrying out a control intervention in the motor vehicle as a function of a setpoint position of the motor vehicle relative to the lane boundary in order to keep the motor vehicle in the lane, ascertaining objects in the area of the lane, and adapting the control intervention as a function of the objects.

The present invention is thus based on the idea that a driver assistance function may exert influence on the driving behavior of the motor vehicle only if no obstacle is detected which a driver may potentially want to avoid. In this way, it is prevented that a driver, during justified evasive maneuvers, experiences automatic interventions which could confuse him/her or pose a hazard to traffic safety. The advantage of the method according to the present invention is thus that the safety is increased for all road users in the area of this method. Moreover, it is achieved that the trust of the driver in driver assistance functions in general is increased, since the number of confusing or erroneous interventions by the driver assistance function is reduced.

The monitoring of the lane preferably takes place with the aid of an optical sensor, for example a video camera. This type of sensor has proven to be particularly advantageous for identifying lane boundaries which define the lane. Alternative sensors are also conceivable, for example a LIDAR sensor, a radar sensor or an ultrasonic sensor. A plurality of sensors which monitor the lane is particularly preferred, which may also include a combination of different sensor types.

The lane boundary is typically designed as a roadway marking, other lane boundaries also being possible here. For example, a lane boundary may also be understood to mean a virtual lane boundary, i.e., for example the assumption of a roadway center by plausible, in particular geometric, partitioning of the entire roadway. Natural roadsides or traffic signs may also serve as a lane boundary.

The relative position of the motor vehicle includes in particular a lateral distance of the motor vehicle from the particular lane boundary. In particular, a lateral distance from the vehicle outer skin to the lane boundary or a lateral distance from a vehicle longitudinal axis to the lane boundary is conceivable.

The control intervention takes place inside the motor vehicle and is used to effectively keep the motor vehicle in the lane. The control intervention may preferably be designed as a steering intervention and/or as a braking intervention. Moreover, a lane center which keeps the motor vehicle centrally between a left and a right lane boundary is conceivable as a setpoint position. As an alternative or in addition, it is possible that the setpoint position is a lateral minimum distance which the motor vehicle must maintain to the lane boundary. This minimum distance may moreover be equal to zero or negative, so that a crossing of the lane boundary by the motor vehicle is also included.

The ascertainment of objects in the area of the lane preferably takes place from sensor data which were generated by a sensor. This may be the same sensor which is used to monitor the lane. Alternatively, it is possible to use a further second sensor, which is used to ascertain objects in the area of the lane. It is particularly preferred to use a radar, LIDAR or stereo-video sensor, which may be used particularly well to identify objects in the area of the motor vehicle.

In one preferred embodiment, the control intervention is reduced or prevented.

In this embodiment, the control intervention is adapted by a reduction in the intensity or by a complete or partial suppression of the control intervention. It is advantageous that very easy implementability of the method is provided since only one signal, the signal resulting in the control intervention, must be adapted or suppressed.

In one further embodiment, the setpoint position is adapted to the object.

In this embodiment, the basis, based on which the control intervention is carried out, is adapted to prevent erroneous interventions. The adaptation of the setpoint position may take place by being shifted by a predetermined or ascertained value in relation to the object. The advantage here is that the driver assistance function itself is adapted to the instantaneous traffic circumstances, and the assistance function is thus preserved. In this way, it is in particular achieved that the driver assistance function is continuously available for the driver, without confusing him/her with a large number of interventions. Moreover, it is an advantage that the driver assistance function itself is very easily adaptable in that the setpoint position is adapted, and the remaining driver assistance function may be maintained.

In one further embodiment of the present invention, a warning is output to the driver upon crossing the lane boundary, the warning taking place independently of the control intervention.

While a warning is output to the driver in this embodiment, the control intervention is decoupled from the warning. In systems from the related art, warnings and control intervention are combined. The warning may take place visually, haptically or acoustically. Although the driver is notified that he/she has crossed the lane boundary, there is no hazard to traffic due to an erroneous control intervention.

In one further embodiment of the present invention, the control intervention is only adapted when a turn signal of the motor vehicle is deactivated.

In this embodiment, the turn signal of the motor vehicle is used to ascertain whether a lane change is intended. As soon as the turn signal is activated, it may be assumed that the driver intends to change lanes. The control intervention is then not adapted by the method. This yields the particular advantage that other functions of the driver assistance functions are frequently completely activated or deactivated as a function of the turn signal. The method provided according to the present invention thus allows it to be combined with such functions without difficulty, so that an economical integration into the motor vehicle is possible.

In one further embodiment of the present invention, the lane is monitored by a video sensor, a radar sensor, a LIDAR sensor and/or an ultrasonic sensor.

It is advantageous to use a radar, LIDAR or video sensor since these may be used particularly well to identify objects in the area of the motor vehicle.

In one further embodiment of the present invention, the adaptation takes place as a function of a relative speed between the motor vehicle and the object.

In this embodiment, a sensor also ascertains a relative speed between the object and the motor vehicle, in addition to the object. The relative speed may be used to establish a relevance of the object for the driver assistance function. At a very low relative speed, for example, it may be assumed that a driving vehicle is involved, which in some circumstances is not relevant for the driver assistance function. This includes a passing situation on a freeway, for example, the host vehicle passing properly. In such a case, it would not be necessary to adapt the control intervention. Moreover, it is conceivable to conclude, at a relative speed close to the vehicle's own speed, that a stationary object is involved, in which case an adaptation of the control invention would definitely be indicated.

In addition, a computer program is advantageous, having program code which may be stored on a machine-readable carrier such as a semiconductor memory, a hard disk memory or an optical memory, and which is configured to carry out the steps of the method according to one of the specific embodiments described above, if the program is executed on a computer or a device.

It shall be understood that the above-mentioned features and those still to be described hereafter may be used not only in the particular described combination, but also in other combinations, or alone, without departing from the scope of the present invention.

### BRIEF DESCRIPTION OF THE DRAWINGS

Exemplary embodiments of the present invention are shown in the figures and are described in greater detail below.

FIG. 1 shows a schematic representation of a motor vehicle in traffic, which uses an example method according to the present invention.

FIG. 2 shows a flow chart of the example method according to the present invention.

### DETAILED DESCRIPTION OF EXAMPLE EMBODIMENTS

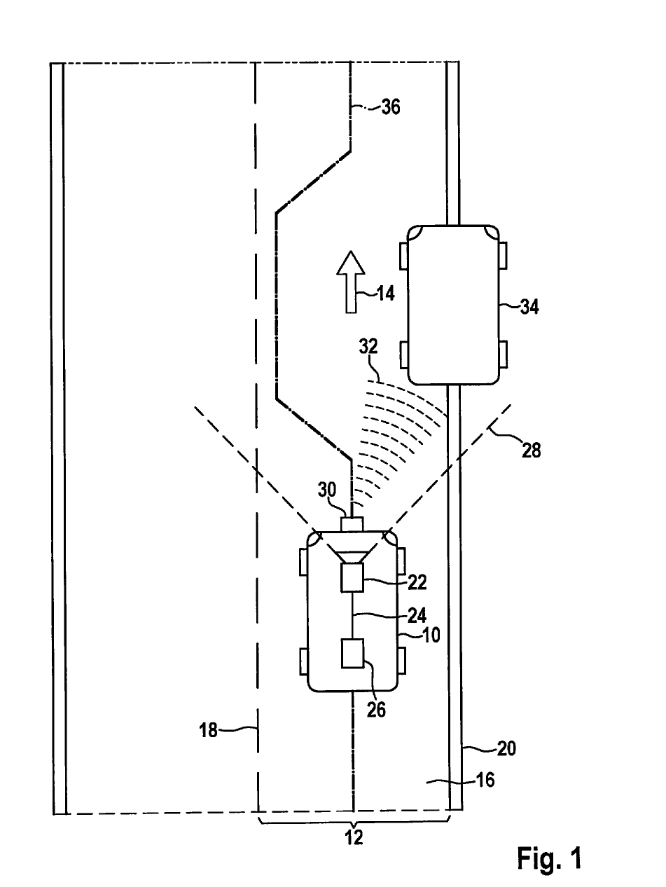

FIG. 1 shows a motor vehicle 10 which is moving in a lane 12 in driving direction 14. Lane 12 is a right lane 12, as viewed in driving direction 14, of a road 16. Lane 12 is defined by a left lane boundary 18 in the form of a broken lane marking, and a right lane boundary 20 in the form of a roadside.

Motor vehicle 10 includes a first optical sensor in the form of a video camera 22. Video camera 22 is connected in terms of signaling to a control and evaluation unit 26 via a line 24. Video camera 22 detects a surrounding area of motor vehicle 10 within its detection range 28. The data thus ascertained are then forwarded to control and evaluation unit 26 via line 24.

Motor vehicle 10 furthermore includes a second sensor in the form of a radar sensor 30. The radar sensor emits a radar signal 32 essentially in driving direction 14. With the aid of radar signal 32, radar sensor 30 is able to detect an object 34. Object 34 is a parking motor vehicle, which is parked partially in lane 12.

Motor vehicle 10 furthermore includes a driver assistance function for maintaining lane 12, which is not shown here and acts on motor vehicle 10. This driver assistance function uses a progression of setpoint position 36, on which motor vehicle 10 is to be moved, as the setpoint value.

It is apparent in the area of object 34 that the progression of setpoint position 35, as viewed in driving direction 14, is shifted to the left. This shift took place as a result of the pieces of information about object 34 in control and evaluation unit 26. Upon identification of object 34, control and evaluation unit 26 accordingly adapted the progression of setpoint position 36. A driver is thus able to continue to steer motor vehicle 10 in the direction, or even over, lane boundary 18, without a steering intervention by the driver assistance function taking place.

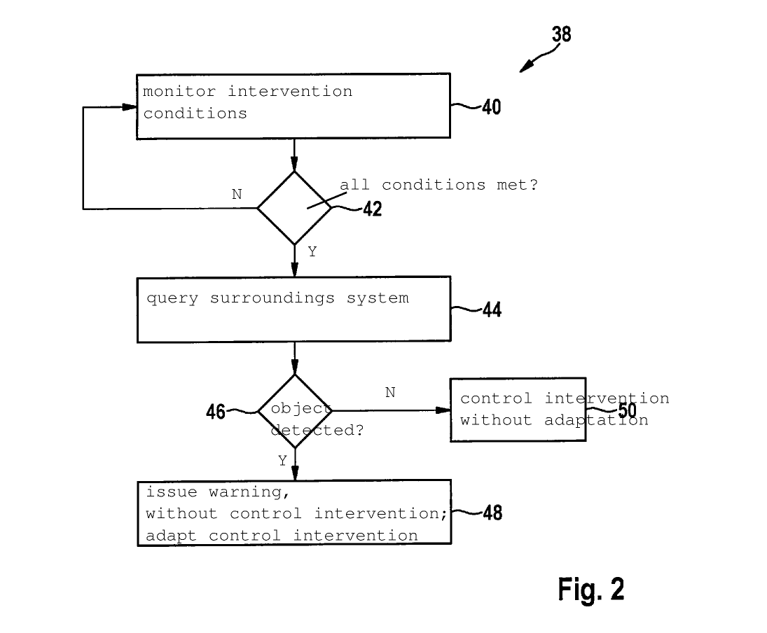

FIG. 2 shows a flow chart 38 which describes the method according to the present invention in greater detail.

In step 40, intervention conditions of the driver assistance function for maintaining the lane are monitored. This includes the monitoring of lane 12 on which motor vehicle 10 is moving. It furthermore includes the ascertainment of lane boundary 18 of lane 12, and the ascertainment of the relative position of motor vehicle 10 with respect to lane boundary 18.

In a subsequent step 42, it is checked whether all conditions for an intervention are met. If this is not the case, a back arrow leads back to step 40, whereby a loop is formed here until the intervention conditions are met. If the intervention conditions are met, the method is continued in a following step 44.

In step 44, sensor 30 is queried with respect to object 34. A query of the surroundings system is thus carried out.

In step 46, the result of this query is evaluated. If object 34 was detected, i.e., an obstacle was identified, the method continues to step 48. If no object 34 was detected, the method continues to a further step 50.

In step 48, a warning is issued to the driver, without a control intervention taking place. Moreover, in preferred exemplary embodiments, an adapted control intervention may take place as a function of object 34.

In step 50, a control intervention without adaptation takes place.

1-10. (canceled)

11. A method for operating a driver assistance function of a motor vehicle for maintaining a lane, comprising:
monitoring a lane on which the motor vehicle is moving;
ascertaining a lane boundary of the lane;
ascertaining a relative position of the motor vehicle with respect to the lane boundary;
carrying out a control intervention in the motor vehicle as a function of a setpoint position of the motor vehicle relative to the lane boundary to keep the motor vehicle in the lane;
ascertaining an object in the area of the lane; and
adapting the control intervention as a function of the object.

12. The method as recited in claim 11, wherein the control intervention is reduced or prevented.

13. The method as recited in claim 11, wherein the setpoint position is adapted to the object.

14. The method as recited in claim 11, wherein a warning is output to the driver upon crossing the lane boundary, the warning taking place independently of the control intervention.

15. The method as recited in claim 11, wherein the control intervention is adapted only when a turn signal of the motor vehicle is deactivated.

16. The method as recited in claim 11, wherein the lane is monitored by at least one of a video sensor, a radar sensor, a LIDAR sensor, and an ultrasonic sensor.

17. The method as recited in claim 11, wherein the adaptation takes place as a function of a relative speed between the motor vehicle and the object.

18. A control and evaluation unit for providing a driver assistance function for a motor vehicle for maintaining a lane, the control and evaluation unit designed to:
monitor a lane on which the motor vehicle is moving;
ascertain a lane boundary of the lane;
ascertain a relative position of the motor vehicle with respect to the lane boundary;
carry out a control intervention in the motor vehicle as a function of a setpoint position of the motor vehicle relative to the lane boundary to keep the motor vehicle in the lane;
ascertain an object in the area of the lane; and
adapt the control intervention as a function of the objects.

19. A non-transitory electronic storage medium on which is stored a computer program for operating a driver assistance function of a motor vehicle for maintaining a lane, the computer program, when executed by a computer, causing the computer to perform:
monitoring a lane on which the motor vehicle is moving;
ascertaining a lane boundary of the lane;
ascertaining a relative position of the motor vehicle with respect to the lane boundary;
carrying out a control intervention in the motor vehicle as a function of a setpoint position of the motor vehicle relative to the lane boundary to keep the motor vehicle in the lane;
ascertaining an object in the area of the lane; and
adapting the control intervention as a function of the object.
